(19) United States
(12) Patent Application Publication
(10) Pub. No.: US 2008/0043759 A1
(43) Pub. Date: Feb. 21, 2008

(54) System, Apparatus, Method and Computer Program Product for an Intercom System

(75) Inventors: John James Poetker, Mt. Airy, MD (US); Jerry Leroy Shumway, Rockville, MD (US); Frank Martinez, Fairfax, VA (US); Mian-Yeu Chiang, Silver Spring, MD (US); Leshui Zhang, Potomac, MD (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Northrop Grumman Systems Corporation

(21) Appl. No.: 11/465,158

(22) Filed: Aug. 17, 2006

(51) Int. Cl. H04L 12/56

(52) U.S. Cl. 370/401; 370/466

(57) ABSTRACT

A network gateway, method and computer program product for providing data translation between dissimilar networks capable of communication at a unit includes a translation element and a routing element. The translation element is configured to translate packet data between different formats of an internal network and a shared network via which the unit is capable of communication with an external unit. The routing element is configured to dynamically update routing tables for routing the packet data based on the content of the packet data. A routing element, apparatus and system for providing intercom services for communication between units are also provided, thereby providing an increased ability to share resources between units.

### FIELD OF THE INVENTION

Embodiments of the present invention relate generally to communication systems, and more particularly, to an intercom communication system.

### BACKGROUND OF THE INVENTION

In the modern world, wireless communications are being integrated into activities of all kinds due to the increasing availability and popularity of wireless communication devices coupled with the mobility of such devices. For example, electronic devices capable of communicating voice content, media, data, etc. are now commonly carried by individuals or are fixtures in vehicles and homes. Numerous networks have been developed to support information exchange using electronic devices having widely varying capabilities and/or purposes.

Many businesses, public service organizations, military organizations and other groups have enhanced or developed areas of their respective operations using wireless communication devices. For example, a small group or even a large fleet of units such as vehicles may be equipped with communication devices which enhance the effectiveness of the group or fleet by enabling the coordination of efforts of the members of the group or fleet. Examples of such groups may include police and rescue vehicles, transportation vehicles, fishing fleets, military convoys, squadrons or combat teams.

Additionally, current technological developments continue to expand upon the types and capabilities of electronic devices that can enhance the effectiveness of an organization's operations. For example, complex electronic sensors, computing systems, devices offering internet access, guidance and navigation systems or other equipment may be incorporated into vehicles to enhance the capabilities of the vehicle. While the addition of communications equipment and other electronic devices certainly improves the ability of each vehicle, a disadvantage of such additions is that it often becomes very expensive and cumbersome to equip each vehicle of a group or fleet with the same equipment. Additionally, numerous networks that are incompatible with each other may necessitate the inclusion of numerous corresponding input/output devices, thereby consuming space and adding weight to electronic suites for employment in vehicles. As an alternative, only a few vehicles of a fleet may have certain expensive equipment suites, while others have limited capabilities. However, this alternative creates imbalances in vehicle capabilities that may result in resource management challenges that would preferably be avoided.

Accordingly, it may be desirable to introduce a device that is capable of making the assets of each individual vehicle or unit available to each other vehicle or unit by providing an interface between dissimilar networks that may exist in each vehicle. Such a device could also be employed apart from vehicles such as, for example, in mobile or fixed communication centers which communicate with other fixed or mobile sites. Thus, communication of voice and data content can be improved while providing an increased access to resources with a reduced requirement for physical instantiation of the resources thereby improving resource efficiency.

### BRIEF SUMMARY OF THE INVENTION

A routing unit having an active channel discriminator is therefore provided that is configured to discriminate in real time sub-sets of communication channels by identifying and processing only those channels that are active. The active channel discriminator may be employed in a gateway device that provides a homogeneous connection between dissimilar networks. When employed in an inter-vehicle intercom system, the gateway device enables the inter-asset intercom system to provide resource sharing between vehicles regardless of the local network with which a resource may be associated. However, it should be noted that the concepts presented herein are applicable not only to inter-vehicle communication but also to communication between any units employing embodiments of the present invention. As such, a unit as referred to hereinafter should be considered, without limitation, to include vehicles, aircraft, water craft, offices, boardrooms, mobile or fixed communication centers, etc.

In one exemplary embodiment, a routing element is provided. The routing element includes a selective filtering portion configured to receive incoming packets and select packets for processing that originate from an address that is active and predefined as an address of interest based on a routing table that is dynamically updated, and an active channel discriminator in communication with the selective filtering portion to receive the selected packets from the selective filtering portion. The active channel discriminator is configured to route packets for processing that originate from an active channel.

In another exemplary embodiment, a network gateway device for providing data translation between dissimilar networks capable of communication at a unit is provided. The network gateway includes a translation element and a routing element. The translation element is configured to translate packet data between different formats of an internal network and a shared network via which the unit is capable of communication with an external unit. The routing element is configured to dynamically update routing tables for routing the packet data based on the content of the packet data.

In other exemplary embodiments, a method and computer program product for providing data translation between dissimilar networks capable of communication at a unit are provided. The, method and computer program produce include operations or executable portions for receiving a data packet in a first format from a first network, selectively filtering the data packet based on the source address of the data packet, routing the data packet via a routing table that is dynamically adjusted based on the content of the data packet, and translating the data packet to a second format suitable for a second network.

In another exemplary embodiment, an inter-unit intercom system for providing intercom communication between units is provided. The inter-unit intercom system includes a first unit and a second unit. The first unit includes a first interface element and a first network gateway. The first interface element is configured to receive data from a first asset of a first network internal to the first unit and convert the received data into packet data and configured to receive packet data from the first network and convert the packet data into data for output by the first asset. The first network gateway is in communication with the first interface element via the first network and in communication with a shared network. The first network gateway includes a translation element configured to translate packet data between different formats of the first network and the shared network, and a routing element configured to dynamically update routing tables for routing the packet data based on the content of the packet data. The second unit includes a second interface element and a second network gateway. The second interface element is configured to receive data from a second asset of a second network internal to the second unit and convert the received data into packet data and configured to receive packet data from the second network and convert the packet data into data for output by the second asset. The second network gateway is in communication with the second interface element via the second network and in communication with the shared network.

Embodiments of the invention provide an increased ability to share resources between units and thereby enable groups of units to enjoy increased capabilities without a requirement to have a physical instance of each asset possessing a particular capability in each of the units. As a result, the volume of electronics suites employed in a unit may be reduced and subsequently cost and weight of a unit can also be reduced.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram illustrating a group of units communicating via an intercom system according to an exemplary embodiment of the invention;

FIG. 2 illustrates a block diagram of a communication element of a unit according to an exemplary embodiment of the invention;

FIG. 3 illustrates a block diagram of a network gateway according to an exemplary embodiment of the invention;

FIG. 4 illustrates a block diagram of a field programmable gate array (FPGA) according to an exemplary embodiment of the invention; and

FIG. 5 shows a flowchart of a method for establishing a seamless intercom connection between a plurality of units.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

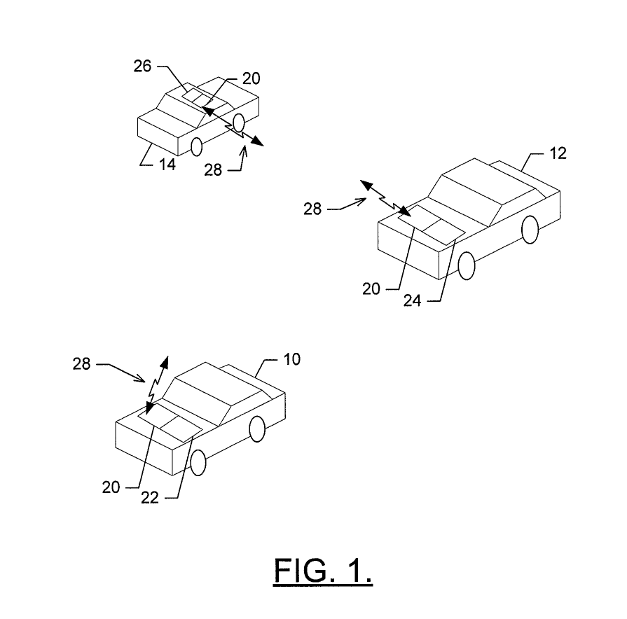

FIG. 1 is a diagram illustrating a group of units capable of communicating via an intercom system according to an exemplary embodiment of the invention. It should be noted initially and throughout the description to follow that although FIG. 1 illustrates an embodiment of the present invention employed in vehicles, embodiments of the present invention may also be employed on other units or platforms as well. In this regard, it should be understood that embodiments may also be employed in apparatuses that may be utilized within any type of unit for communication with other units. For example, a unit capable of employing embodiments of the present invention could be any type of vehicle, aircraft, water craft, office, command post, etc. Additionally, although FIG. 1 shows three vehicles or units, it should be understood that any number of units could employ embodiments of the present invention. In other words, embodiments of the present invention are scalable to support operation including any number of units from two to hundreds or even thousands of units. In this regard, FIG. 1 is merely provided for purposes of example and not of limitation.

Referring now to FIG. 1, a group of units capable of communication via an intercom system according to an exemplary embodiment of the present invention includes a first vehicle 10, a second vehicle 12, and a third vehicle 14. Each of the first, second and third vehicles 10, 12 and 14 may include a corresponding first internal network 22, a second internal network 24 and a third internal network 26 in communication with a communication element 20 according to an exemplary embodiment. The communication element 20 of each of the first, second and third vehicles 10, 12 and 14 may be capable of communication with each other one of the first, second and third vehicles 10, 12 and 14 via communication links 28. In an exemplary embodiment, the communication links 28 may be established via an internet protocol (IP) radio frequency (RF) communication link. However, any other suitable communication link may also be employed. The first, second and third internal networks 22, 24 and 26 may include any number of assets internal to the corresponding vehicle and each of the assets could be unique to the corresponding vehicle. For example, assets in the first internal network 22 could include a particular tactical radio and a particular sensor device while assets in the second internal network could include a different tactical radio and a different sensor device.

Communications via the communication element 20 may be conducted in numerous modes. For example, communications could be conducted in a push-to-talk format in one mode, while other modes may enable transmission of any audio input above a particular threshold (i.e., VOX mode) or transmission of every detectable audio input (i.e., hot mode).

In an exemplary embodiment, as shown in FIG. 1, when the first, second and third vehicles 10, 12 and 14 are in proximity, communication may be established between corresponding internal networks of each of the vehicles using the communication elements 20 of each of the vehicles via the communication links 28. An allowable distance between vehicles which supports communication via the communication links 28 will depend upon the properties of the communication links 28. In this regard, some communication links 28 may only be effective at distances measured in the hundreds of yards, while others may be effective over the horizon. Additionally, in certain embodiments it may be possible to establish communications between units using wireless or wired communication networks such as, for example, wireless local area networks (WLANs), Bluetooth, cellular networks or publicly switched telephone networks.

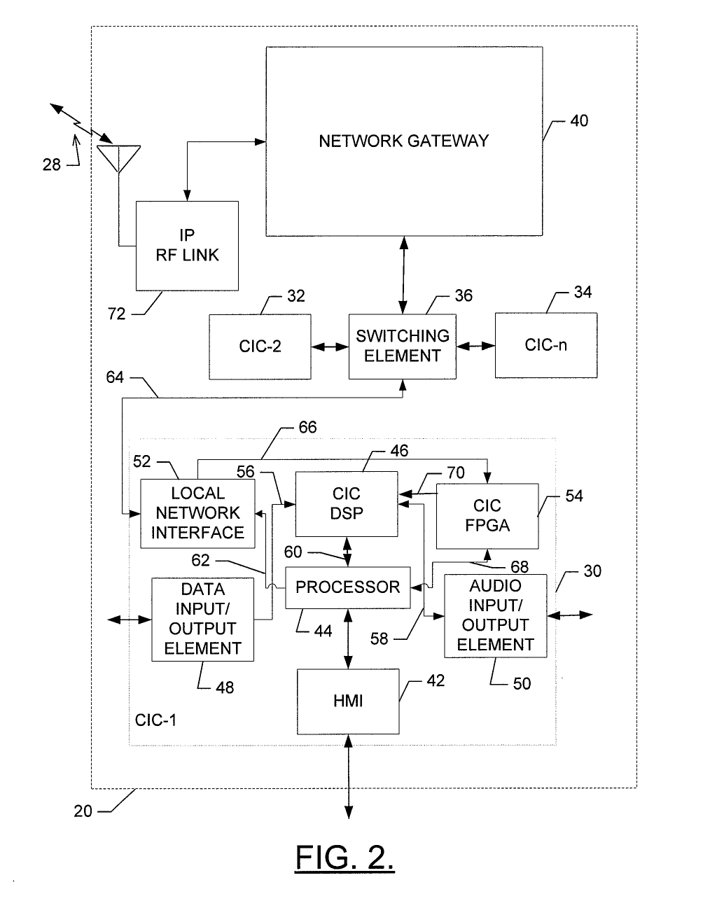

FIG. 2 illustrates a block diagram of the communication element 20 according to an exemplary embodiment. The communication element 20 may include an interface element such as a first crew interface center (CIC-1) 30 and a network gateway 40. In an exemplary embodiment as shown in FIG. 2, the communication may include multiple CICs such as a second CIC (CIC-2) 32 and an n^{th} CIC (CIC-n) 34. Each of the CICs may be in communication with the network gateway 40 via a switching element 36 which may be, for example, an Ethernet switch. Although the switching element 36 is shown separate from the network gateway 40 in FIG. 2, it should be understood that the switching element 36 could alternatively be a portion of the network gateway 40. Additionally, it should be understood that each of the CICs (i.e., CIC-1 30 to CIC-n 34) may be similar in construction to that shown for CIC-1 30. Furthermore, although this exemplary embodiment refers to CICs, it should be understood that in other exemplary embodiments in which the communication element 20 is employed in environments other than vehicles, the CICs may instead be referred to simply as interface centers.

Each CIC may be any device or means embodied in either hardware, software, or a combination of hardware and software that is capable of accepting operator input for control of communication between various assets of an internal network and the network gateway 40. As shown in FIG. 2, the CIC-1 30 may include a human to machine interface (HMI) 42, a processor 44, a CIC digital signal processor (DSP) 46, a data input/output element 48, an audio input/output element 50, a local network interface 52 and a CIC field programmable gate array (FPGA) 54. Each of the elements above may be any device or means embodied in either hardware, software, or a combination of hardware and software that is capable of performing the corresponding functions associated with each of the elements above as described below.

The data input/output element 48 and the audio input/output element 50 are each capable of interfacing with various assets of an internal or local network of the corresponding vehicle in which the communication element 20 is disposed. In this regard, the data input/output element 48 may function as a converter for converting incoming data into digital data for payload placement in the CIC DSP 46 and converting outgoing data into a digital format that is suitable for use at a corresponding asset which may act as an output device. The audio input/output element 50 may include analog to digital and digital to analog converters and/or compression and decompression devices or codecs for performing conversion and compression/decompression for incoming and outgoing data. In this regard, the audio input/output element 50 may convert incoming audio into a digital format. Meanwhile, outgoing audio data may be decompressed and/or converted to analog data for output to a speaker or other output device. It should be noted that, as used above, the term incoming refers to data that is coming into the CIC-1 30 via either of the data input/output element 48 and the audio input/output element 50, while the term outgoing refers to data that is leaving the CIC-1 30 via either of the data input/output element 48 and the audio input/output element 50.

Incoming data is processed in either the data input/output element 48 or the audio input/output element 50 and then communicated to the CIC DSP 46 via lines 56 and 58, respectively. The CIC DSP may perform compression, filtering, summing, tone generation, tone detection and/or conversion upon audio packets in order to convert incoming audio packets from the audio input/output element 50 into, for example, real time transfer protocol (RTP) packets. The RTP packets may then be communicated to processor 44 for communication to the local network interface 52 at lines 60 and 62, respectively. The processor 44 may employ multicast addressing for each separate audio source. It should be noted that although RTP packets are referred to above, any other suitable protocol may also be employed. As such, RTP packets are merely provided by way of example and not of limitation.

The HMI 42 may be any HMI known in the art and is typically capable of providing operator input or control to the processor 44 for such operations as, for example, mode selection, channel selection, tuning operations, input of addresses from which communications should be monitored, etc. The processor 44 may be any typical processing element. A processing element such as those described herein may be embodied in many ways. For example, the processing element may be embodied as a processor, a coprocessor, a controller or various other processing means or devices including integrated circuits such as, for example, an ASIC (application specific integrated circuit). In this example, the processor 44 communicates with elements of the CIC-1 30 to distribute packet data to various other respective elements of the CIC-1 30 depending upon, for example, the mode of operation of the CIC-1 30 as determined by the HMI 42.

The local network interface 52 may provide an interface between the CIC-1 30 and an internal or local network of the corresponding vehicle. In this regard, the local network interface 52 may represent a media access control (MAC) layer and a physical layer interface between the CIC-1 30 and the local network. The local network is common to all assets of the corresponding vehicle and is shared between each of the CICs. The assets could include, for example, multiple radios, sensors, guidance equipment, communications equipment, or other electronic devices. As stated above, the local network interface 52 may receive packet data from the processor 44 via the line 62. The packet data may then be communicated to the local network as shown at line 64 via the local network interface 52. Additionally, the line 64 may communicate the packet data to the network gateway 40 via the switching element 36. Meanwhile, data coming into the CIC-1 30 from the local network may be communicated to the local network interface 52 via the line 64 and then communicated to the CIC FPGA 54 via line 66.

The CIC FPGA 54 may be any FPGA known in the art. In an exemplary embodiment, the CIC FPGA 54 is configured to perform processing and switch routing of data. In this regard, the CIC FPGA 54 may process the data received via line 64 synchronously in real time in order to determine whether the source address, which may be evident from the packet data, of each packet is of interest. The processor 44 may be utilized, for example, via user input from the HMI 42, to provide external programming regarding which source addresses are of interest via line 68. In other words, the user may select which source addresses the user would like to have processed by selecting a particular source address as being “of interest”. In this regard, source addresses that are of interest may be determined by the CIC FPGA 54 and only those source addresses that have been selected as being of interest may be processed by the CIC DSP 46 and/or the processor 44, thereby reducing the processing load on the CIC DSP 46 and/or the processor 44. In an exemplary embodiment, the user may select either all available sources or all sources of a particular type as being of interest.

Incoming data and audio packets may also be communicated to the CIC FPGA 54 via the processor 44 after processing at the CIC DSP 46. After processing at the CIC FPGA 54, the incoming data and audio packets may then be communicated to the local network interface 52 via the processor 44. Audio packets received from the local network interface 52 may be communicated directly from the CIC FPGA 54 to the CIC DSP 46 via line 70. The CIC DSP 46 may then process the audio packets received from the local network interface 52 into digital audio for output via the audio input/output element 50.

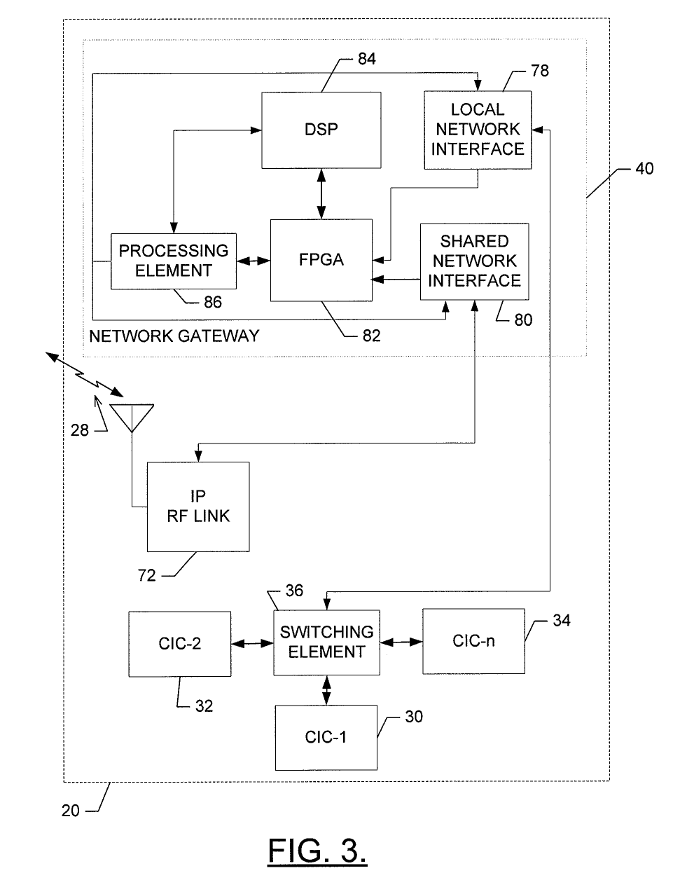

Data communicated via the local network may be transferred to or received from the network gateway 40. The network gateway 40 may be any device or means embodied in either hardware, software, or a combination of hardware and software that is capable of acting as a gateway between dissimilar networks. In other words, the network gateway 40 provides a mechanism by which numerous local networks, which may be dissimilar to each other, may communicate via a common shared network. Networks may be considered dissimilar if data packets carried by respective networks contain payloads that include data or speech information that has been digitized and/or encoded using different techniques or algorithms, thereby rendering a particular payload unique to its respective particular network and unusable by nodes or assets in other networks that do not employ the digitizing and/or encoding techniques or algorithms that were used to form the data packet payload. In operation, the communication links 28 may provide a connection between units such as the first, second and third vehicles 10, 12 and 14, such that assets internal to one of the vehicles may be accessed by another of the vehicles via the network gateway 40 of each corresponding vehicle. More specifically, the network gateway 40 may be in communication with an IP RF link 72 of each corresponding vehicle, which may provide communication between vehicles via the communication links 28. The network gateway 40 may then provide a translation or interface between the local network of each corresponding vehicle and the common shared network as described in greater detail below with reference to FIG. 3.

FIG. 3 illustrates a block diagram of the network gateway 40 according to an exemplary embodiment of the invention. As shown in FIG. 3, the network gateway 40 may include a local network interface 78, a shared network interface 80, an FPGA 82, a DSP 84 and a processing element 86. Each of the elements above may be any device or means embodied in either hardware, software, or a combination of hardware and software that is capable of performing the corresponding functions associated with each of the elements above as described below. The DSP 84 may function as a translation element providing translation between packet data of dissimilar networks as described in greater detail below. Meanwhile, the FPGA 82 may function as a routing element that dynamically updates packet data routing based on the content of the packet data and filters packet data based on the source address of the packet data.

The local network interface 78 may be substantially similar to the local network interface 52 of the CIC-1 30. In this regard, the local network interface 78 provides an interface between the network gateway 40, the local network and the local network interfaces of each of the CICs via the switching element 36. The local network interface 78 may receive packet data from or communicate packet data to any of the CICs. When receiving packet data from one of the CICs, the local network interface 78 and the shared network interface 80 may communicate the received packet data to the FPGA 82.

The FPGA 82 processes and routes packets received from one of the local or shared networks and class marks or identifies from which network the packet was received prior to forwarding the packet to the DSP 84. The processing element 86, which is in communication with the FPGA 82, may be used to program the FPGA 82 to filter selected packets incoming from the local network interface 78 and/or the shared network interface 80. Thus, the FPGA 82 forwards only the selected packets to the DSP 84 for processing. In general the selected packets that are sent from the FPGA 82 to the DSP 84 may be speech or other types of data such as streamed packets which may include, for example, RTP packets. In an exemplary embodiment, since all packets may be class marked by the FPGA 82, the DSP 84 may process each packet differently according to the particular type of packet or derivation of the packet as indicated by the class mark. For example, packets may be class marked according to their origin, type, DSP channel, etc. Accordingly, speech packets may be processed through a respective speech decoder and other types of data which may require high-level data link control (HDLC) decoding or other types of decoding may be decoded to present binary coded decimal (BCD) data words or values as appropriate.

The DSP 84 may be configured to decompress, modify and/or recompress packet data payloads from either network for transmission over the opposite network via the processing element 86. In other words, the DSP 84 provides the translation of data from dissimilar networks so that, regardless of the local network of origination at an originating vehicle, data packets may be processed and translated at the DSP of the originating vehicle into a format suitable for transmission via the common shared network to a receiving vehicle. The DSP of the receiving vehicle then translates the data packets from the format suitable for transmission via the common shared network into a format suitable for output at the receiving vehicle via the local network of the receiving vehicle. The processing element 86 may provide routing information to the DSP 84 to indicate which packets from a particular network are to be pre-summed with packets of another particular network or other particular networks. The routing information from the processing element 86 may also provide an input to the DSP 84 to indicate which packets (pre-summed or otherwise) are to be transmitted on a specific network and to a specific address. In this regard, the DSP 84 may pre-sum all data that is addressed to a particular point or address on any of the different networks and output only one data stream for the particular point or address. In this way, the DSP 84 is capable of modifying addressing (such as by conversion) and pre-summing data. Accordingly, bandwidth requirements for networks may be reduced and the processing load on individual nodes of the receiving network may also be reduced. Data leaving the DSP 84 is typically communicated to the processing element 86 which forwards packets that have been transformed, summed or otherwise processed at the DSP 84 to the respective destination network (i.e., via either the local network interface 78 or the shared network interface 80) based on the class marking or identification performed by the FPGA 82.

The DSP 84 is also capable of decompressing and recompressing data dependent upon the destination of the data. In this regard, the DSP 84 is capable of processing speech data to convert dissimilar voice sample and compression schemes so that dissimilar rates are interoperable, thereby providing a seamless connection between networks that have different speech compression and/or decompression schemes. As a result, the DSP 84 enables the seamless connection of dissimilar networks having data in which payloads are not compatible to create a homogeneous connection by which members of different networks can process each other's data without requiring each member to host multiple processing devices for each type of dissimilar data. Thus, in an exemplary embodiment, an operator in a first vehicle having a first internal network may request control of an asset in a second vehicle via a CIC. The CIC may then communicate the request which is in a first format or protocol that is useable on the first internal network to the network gateway of the first vehicle. The network gateway of the first vehicle may then translate the request to a format or protocol that is useable on a shared network. The second vehicle may then receive the request via the shared network at the network gateway of the second vehicle which translates the request into a format or protocol that is useable in a second internal network of the second vehicle. The second vehicle may send an acknowledgement message to the first vehicle via the shared network to relinquish control of the asset to the first vehicle. The asset of the second vehicle may then be controlled from the first vehicle via the shared network using the corresponding network gateways of the first and second vehicles as translators between the internal networks of the corresponding vehicles and the shared network. Thus, the asset becomes a virtual asset of the first vehicle. It should be noted that although in an exemplary embodiment control of the asset may be relinquished, control may also be shared such as, for example, during use in a conference.

The FPGA 82 may also forward certain packets directly to the processing element 86 for subsequent communication to whichever of the local network interface 78 or the shared network interface 80 that the packets have not originated from with respect to the network gateway 40. In other words, for example, if a particular packet enters the network gateway 40 from another vehicle via the shared network interface 80 and is forwarded directly to the processing element 86, then the particular packet may be communicated to a CIC via the local network interface 78. Packets that are passed directly from the FPGA 82 to the processing element 86 are typically system control or configuration messages of interest to the processing element 86. For example, the acknowledgement message of the example above is a type of system control or configuration message that may be transmitted directly to the processing element 86 from the FPGA 82 without first being communicated to the DSP 84. In this regard, the acknowledgement message would be of interest since the processing element 86 would expect an acknowledgement from that particular source. However, if an acknowledgement message is received from another source to which no request was issued, then the processing element 86 would not recognize such acknowledgement message as being of interest.

The network gateway 40 is also capable of routing particular packets of data based upon dynamically updated routing tables. It should be noted that while many conventional routing tables may be said to be “dynamically updated”, such routing tables are typically updated from an external source. The network gateway 40 is configured to provide, via the FPGA 82, a mechanism for providing automatic internally generated updates to routing tables based on message content of the message or packet to be routed instead of based on instructions from external sources. For example, in the example described above in which the acknowledgement message was transmitted from the second vehicle, receipt of the acknowledgement message at the processing element 86 may cause the processing element 86 to alter the routing tables of the FPGA 82 to reflect that control of the asset is shifted to the first vehicle. Accordingly, the contents of the message (i.e., that control of the asset has shifted) are examined to determine dynamic changes to the routing tables for data packets processed in the network gateway 40.

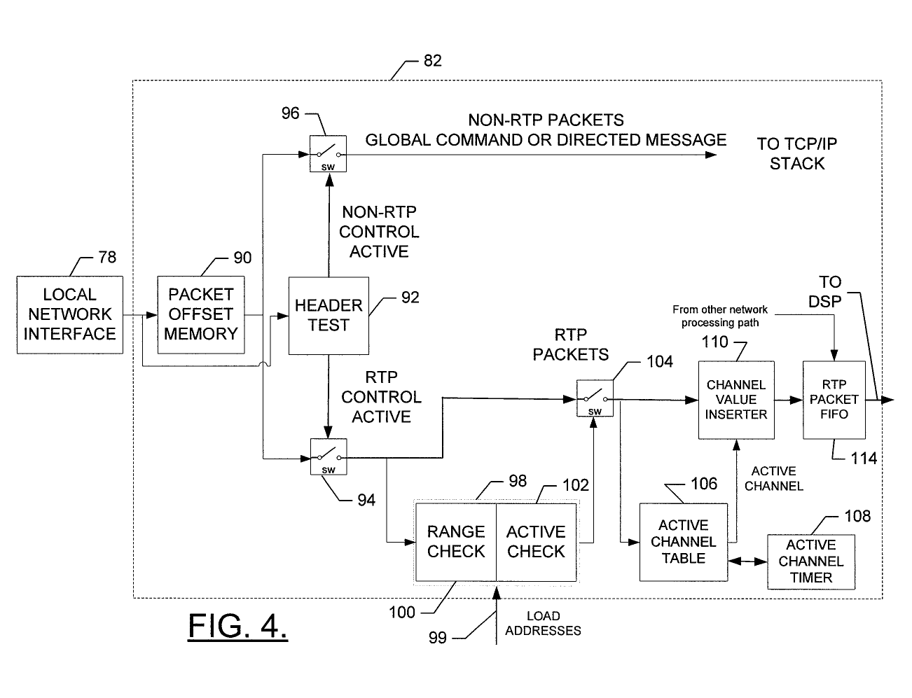

FIG. 4 illustrates a block diagram of the FPGA 82 according to an exemplary embodiment of the invention. As shown in FIG. 4, packets may enter the FPGA 82 from a particular network such as either the local network interface 78 or the shared network interface 80. In this regard, it should be noted that although FIG. 4 shows the local network interface 78 as providing an input into the FPGA 82, the elements of the FPGA 82 are also duplicated with respect to the shared network interface 80. As such, for the sake of simplicity of explanation, FIG. 4 merely shows one of the duplicate processing paths within the FPGA 82 and it should be understood that an identical processing path is provided for the corresponding shared network interface 80 with the exception of an RTP packet FIFO 114, which is shared between both the illustrated processing path for data input from the local network interface 78 and the processing path for data input to the FPGA 82 from the shared network interface 80. Upon entering the FPGA 82, the packets are communicated to both a packet offset memory 90 and a header test 92. The packet offset memory 90 and the header test 92 may provide source address pre-processing filtration to separate audio packets and non-audio packets such as, for example, by separating RTP and non-RTP packets. In this regard, the packet offset memory 90 may include, for example, a two or three bit clock to delay incoming packets while source address data is examined. Meanwhile, the header test 92 controls operation of switch 94 and switch 96 based on the type of packet and whether the packet is a packet of interest based on the source address. For example, if the packet is not a packet of interest (i.e., the source address has not been identified as being of interest by the user), then neither switch 94 nor switch 96 is closed and the packet is not passed for further processing thereby saving processor cycles and reducing resource consumption. If the packet is a non-RTP packet (i.e., system control data or other data that is not streamed), then switch 96 closes while switch 94 remains open in order to pass the packet, for example, to the TCP/IP stack for processing. If the packet is an RTP packet such as streaming voice data, then switch 94 closes while switch 96 remains open in order to pass the RTP packet to an address filter 98. The address filter 98 may receive an input 99 from the user defining addresses of interest. In practice, the input 99 may be received from the processing element 86. The input 99 may dynamically change as the routing tables are changed as described above. The addresses of interest may be defined in terms of address ranges which, for example, may provide a series of addresses involved in a particular conference or intercom conference. The address filter includes a range check element 100 and an active check element 102. The range check element 100 determines whether the source address of the RTP packet is within the address ranges defined in the range check element 100 as corresponding to addresses of interest. The RTP packet will pass the range check if the address of the RTP packet is within the ranges of addresses defined as being of interest. The active check element 102 determines whether the source address of the RTP packet is an active source (i.e., a source that is currently in communication or participating in a conference). The RTP packet will pass the active check if the source address of the RTP packet is determined as being an active source. If both the active check and the range check are passed, the address filter 98 will cause switch 104 to close, thereby passing the RTP packet for further processing at an active channel discriminator. The packet offset memory 90, the header test 92, switches 94, 96 and 104, and the address filter 98 may be considered as part of a selective filtering portion of the FPGA 82.

In an exemplary embodiment, the active channel discriminator includes an active channel table 106, an active channel timer 108 and a channel value inserter 110. The active channel table 106 includes a table of active conference channels and determines whether each active conference channel currently has an active speaker based on receipt of packets from the corresponding channel. Any number of active conference channels could be listed in the table. The active channel timer 108 maintains a timer for each of the active conference channels which is reset each time a corresponding active conference channel receives an active payload. If the active channel timer 108 times out or expires, the corresponding active conference channel is cleared until another active payload is received, thereby again reducing processor cycles and resource consumption by preventing channel overrunning in the event of silence or packet loss. Accordingly, a large number of channels may be processed while only those channels that are active are forwarded for payload decomposition. If a particular channel is active and the timer has not timed out for the channel, then the channel value inserter 110 inserts corresponding packets into a channel that is meaningful to or otherwise usable by the DSP 84. The packets then enter a buffer such as the RTP packet FIFO 114 which may act as a buffer of, for example, 8 to 16 packets in order to buffer the packet prior to communication of the packet to the DSP 84.

When a data packet enters the FPGA 82, a decision may be made as to whether the data packet is from a source of interest and an RTP packet. If the data packet is an RTP packet from a source of interest, then the address is filtered according to whether the source address is in a selected range of interest and active. Thus, in operation, for example, a particular conference could include 1000 units (i.e., active channels). For example, all 1000 units could have source addresses of interest, but maybe only 50 will be active on a regular basis. Thus, by clearing channels associated with non-active speakers, the load on the DSP 84 is reduced and the processing required to run the conference is correspondingly reduced, while the latency of the communication is not significantly increased. In an exemplary embodiment, the processing above may be accomplished within about 8 to 16 microseconds.

Accordingly, the FPGA 82 is capable of performing a real time discrimination controlled by datagram network address, type and status. In this regard, the FPGA 82 discriminates subsets of voice communication channels among super-sets of voice communication channels by processing only those channels that are active. Control of the discrimination may be dynamically changed as commanded by actions of a user or operator. In other words, an operator may select channels in the super-set, while the FPGA 82 forms subsets from among the channels of the super-set. Accordingly, the operator or user may configure the communication element 20 to enable the unit to participate in multiple large conferences simultaneously.

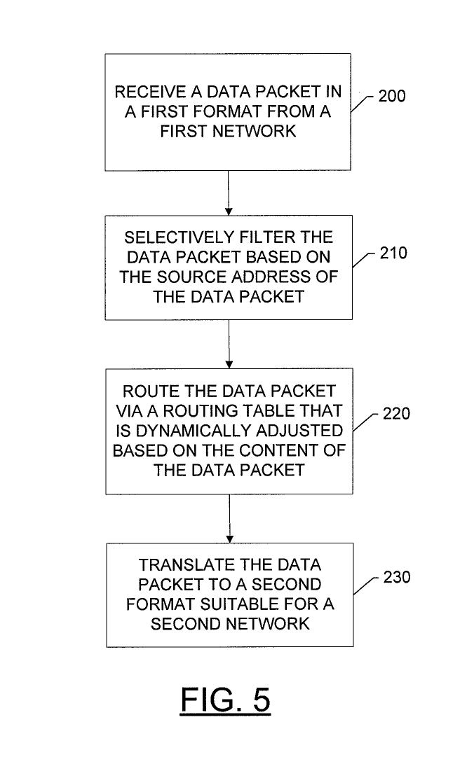

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

As shown in FIG. 5 a method for establishing a seamless intercom connection between a plurality of units includes receiving a data packet in a first format from a first network at operation 200. At operation 210, the data packet is selectively filtered based on the source address of the data packet. The data packet is then routed via a dynamically adjusted routing table at operation 220. At operation 230, the data packet is translated to a second format suitable for a second network. In an exemplary embodiment, the first network may be an internal network of a vehicle and the selective filtering may be performed in response to a user selection of addresses of interest. The dynamic adjustment of the routing table may be performed based on the content of the data packet and the second network may be a shared network via which the data packet may be transmitted, wirelessly or otherwise, to another vehicle. Accordingly, when employed in a system involving multiple vehicles or units, the method above may enable provision of intercom services for communication between vehicles or units, thereby providing an increased ability to share resources between the vehicles or units.

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, while embodiments of the invention may be described in terms of establishing an intercom system between vehicles, other embodiments may establish an intercom system between other units or offices, boardrooms, etc. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A network gateway for providing data translation between dissimilar networks capable of communication at a unit, the network gateway comprising:
a translation element configured to translate packet data between different formats of an internal network and a shared network via which the unit is capable of communication with an external unit; and
a routing element configured to dynamically update routing tables for routing the packet data based on the content of the packet data.

2. The network gateway of claim 1, wherein the network gateway is configured, via the translation element and the routing element, to shift control of the asset to the external unit enabling the asset to function as a virtual asset of the external unit.

3. The network gateway of claim 1, wherein the network gateway is configured, via the translation element and the routing element, to shift control of an asset of the external unit to the interface element enabling the asset of the external unit to function as a virtual asset of the unit.

4. The network gateway of claim 1, wherein the routing element is further configured to filter packet data based on the source address of the packet data.

5. The network gateway of claim 4, wherein the routing element is further configured to filter the packet data based on whether the source address comprises an address of interest as defined by a user.

6. The network gateway of claim 1, wherein the translation element is configured to decompress and recompress packet data based upon a destination of the packet data as determined by the routing element.

7. The network gateway of claim 1, wherein the translation element is configured to pre-sum all data addressed to a common address to output a single stream of data for the common address.

8. The network gateway of claim 1, wherein the routing element is further configured to perform a real time discrimination of subsets of voice communication channels among super-sets of voice communication channels by processing only those channels that are active.

9. The network gateway of claim 8, wherein the routing element includes a timer configured to identify a voice communication channel as active in response to receipt of a packet via the voice communication channel within a predefined period of time.

10. The network gateway of claim 9, wherein the routing element is configured to clear a channel in response to the predefined period of time expiring prior to receipt of a new packet.

11. A method of providing data translation between dissimilar networks capable of communication at a unit, the method comprising:
receiving a data packet in a first format from a first network;
selectively filtering the data packet based on the source address of the data packet;
routing the data packet via a routing table that is dynamically adjusted based on the content of the data packet; and
translating the data packet to a second format suitable for a second network.

12. The method of claim 11, further comprising transmitting the data packet to an external unit.

13. The method of claim 12, further comprising shifting control of an asset from one unit to an external unit via the data translation such that the asset functions as a virtual asset of the external unit.

14. The method of claim 11, further comprising filtering the data packet based on the source address of the packet data.

15. The method of claim 14, wherein filtering the data packet comprises filtering the data packet based on whether the source address is an address of interest as defined by a user.

16. The method of claim 14, wherein selectively filtering comprises an initial operation of dividing packets into packets that are streamed and packets that are not streamed prior to filtering the data packet based on the source address of the packet data.

17. The method of claim 11, wherein routing the data packet further comprises one of decompressing or recompressing the data packet based upon a destination of the data packet.

18. The method of claim 11, wherein translating the data packet comprises pre-summing all data addressed to a common address to output a single stream of data for the common address.

19. The method of claim 11, further comprising performing a real time discrimination of subsets of voice communication channels among super-sets of voice communication channels by processing only those channels that are active.

20. A computer program product for providing data translation between dissimilar networks capable of communication at a unit, the computer program product comprising at least one computer-readable storage medium having computer-readable program code portions stored therein, the computer-readable program code portions comprising:
a first executable portion for receiving a data packet in a first format from a first network;
a second executable portion for selectively filtering the data packet based on the source address of the data packet;
a third executable portion for routing the data packet via a routing table that is dynamically adjusted based on the content of the data packet; and
a fourth executable portion for translating the data packet to a second format suitable for a second network.

21. The computer program product of claim 20, further comprising a fifth executable portion for shifting control of an asset from one unit to an external unit via the data translation such that the asset functions as a virtual asset of an external unit.

22. The computer program product of claim 20, further comprising a fifth executable portion for filtering the data packet based on the source address of the packet data.

23. The computer program product of claim 20, wherein the third executable portion includes instructions for decompressing and recompressing the data packet based upon a destination of the data packet.

24. The computer program product of claim 20, wherein the fourth executable portion includes instructions for pre-summing all data addressed to a common address to output a single stream of data for the common address.

25. The computer program product of claim 20, further comprising a fifth executable portion for performing a real time discrimination of subsets of voice communication channels among super-sets of voice communication channels by processing only those channels that are active.

26. An apparatus for providing intercom services to a unit, the apparatus comprising:
an interface element configured to receive data from an asset and convert the received data into packet data for communication via an internal network of the unit and configured to receive packet data from the internal network and convert the packet data into data for output by the asset; and
a network gateway in communication with the interface element via the internal network, the network gateway including:
a translation element configured to translate packet data between different formats of the internal network and a shared network via which the unit is capable of communication with an external unit; and
a routing element configured to dynamically update routing tables for routing the packet data based on the content of the packet data.

27. The apparatus of claim 26, wherein the routing element is further configured to filter packet data based on the source address of the packet data.

28. The apparatus of claim 27, wherein the routing element is further configured to filter the packet data based on whether the source address is an address of interest as defined by a user via the interface element.

29. A routing element comprising:
a selective filtering portion configured to receive incoming packets and select packets for processing that originate from an address that is active and predefined as an address of interest based on a routing table that is dynamically updated; and
an active channel discriminator in communication with the selective filtering portion to receive the selected packets from the selective filtering portion, the active channel discriminator being configured to route packets for processing that originate from an active channel.

30. The routing element of claim 29, wherein the routing table is dynamically updated based on the content of packet data.

31. The routing element of claim 29, wherein the active channel discriminator is further configured to perform a real time discrimination of subsets of voice communication channels among super-sets of voice communication channels by processing only those channels that are active.

32. The routing element of claim 31, wherein the super-sets of voice communication channels are selected by a user.

33. The routing element of claim 31, wherein the active channel discriminator includes a timer configured to identify a voice communication channel as active in response to receipt of a packet via the voice communication channel within a predefined period of time.

34. The routing element of claim 33, wherein the active channel discriminator is configured to clear a channel in response to the predefined period of time expiring prior to receipt of a new packet.

35. A system for providing intercom communication between units, the system comprising:
a first unit including:
a first interface element configured to receive data from a first asset of a first network internal to the first unit and convert the received data into packet data and configured to receive packet data from the first network and convert the packet data into data for output by the first asset; and
a first network gateway in communication with the first interface element via the first network and in communication with a shared network, the first network gateway including:
a translation element configured to translate packet data between different formats of the first network and the shared network; and
a routing element configured to dynamically update routing tables for routing the packet data based on the content of the packet data; and
a second unit including:
a second interface element configured to receive data from a second asset of a second network internal to the second unit and convert the received data into packet data and configured to receive packet data from the second network and convert the packet data into data for output by the second asset; and
a second network gateway in communication with the second interface element via the second network and in communication with the shared network.

36. The system of claim 35, wherein the first network gateway and the second network gateway are configured to cooperate to shift control of the first asset to the second unit enabling the first asset to function as a virtual asset of the second unit.

37. The system of claim 35, wherein the first network gateway and the second network gateway are configured to cooperate to shift control of the second asset to the first unit enabling the second asset to function as a virtual asset of the first unit.

38. The system of claim 37, wherein the routing element is further configured to filter packet data based on the source address of the packet data.

39. The system of claim 35, wherein the translation element is configured to pre-sum all data addressed to a common address to output a single stream of data for the common address.

40. The system of claim 35, wherein the routing element is further configured to perform a real time discrimination of subsets of voice communication channels among super-sets of voice communication channels by processing only those channels that are active.
